(19) United States
(12) Patent Application Publication
(10) Pub. No.: US 2020/0218500 A1
(43) Pub. Date: Jul. 9, 2020

(54) SYSTEM AND METHOD FOR AUDIO INFORMATION INSTRUCTION

(71) Applicant: Joseph Thomas Hanley, Alexandria, VA (US)

(72) Inventor: Joseph Thomas Hanley, Alexandria, VA (US)

(21) Appl. No.: 16/691,945

(22) Filed: Nov. 22, 2019

Related U.S. Application Data
(60) Provisional application No. 62/788,524, filed on Jan. 4, 2019.

(51) Int. Cl. G06F 3/16; G06F 9/451; G06F 16/64; G06F 16/68

(52) U.S. Cl. CPC G06F 3/165; G06F 16/686; G06F 16/64; G06F 9/451

(57) ABSTRACT

A system is disclosed. The system has an audio instruction module, comprising computer-executable code stored in non-volatile memory, a processor, and a user interface. The audio instruction module, the processor, and the user interface are configured to provide a DAW environment for a user, provide a MIDI editor in the DAW environment to the user, audibly provide a sound recording to the user during a first time period, edit a first data using the MIDI editor during a second time period, compare the first data to a second data defining the sound recording, and provide a feedback data to the user, the feedback data comparing the first data to the second data. The first time period is separate from the second time period.

### CROSS-REFERENCE TO RELATED APPLICATIONS

This application claims the benefit of the following provisional application: 62/788,524 filed Jan. 4, 2019, the entire disclosure of which is incorporated herein by reference.

### TECHNICAL FIELD

The present disclosure is directed to a system and method for instruction, and more particularly, for audio information instruction.

### BACKGROUND OF THE DISCLOSURE

Conventional approaches to teaching music composition are generally effective for musicians who use notation software or handwritten music. For example, music composition may be conventionally taught using traditional music notation and a music staff, a method that has been used for centuries. Such conventional techniques, however, do not typically work effectively with devices such as computers, tablets, and phones.

Some musicians attempt to compose music using conventional notation software, such as a computerized software version of sheet music. However, these conventional methods are typically not effective in providing ear training, which may hamper learning music composition.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a system. The system includes an audio instruction module, comprising computer-executable code stored in non-volatile memory, a processor, and a user interface. The audio instruction module, the processor, and the user interface are configured to provide a DAW environment for a user, provide a MIDI editor in the DAW environment to the user, audibly provide a sound recording to the user during a first time period, edit a first data using the MIDI editor during a second time period, compare the first data to a second data defining the sound recording, and provide a feedback data to the user, the feedback data comparing the first data to the second data. The first time period is separate from the second time period.

In another aspect, the present disclosure is directed to a method. The method includes providing a DAW environment for a user via a user interface, providing a MIDI editor in the DAW environment to the user, audibly providing a sound recording to the user during a first time period, editing a first data using the MIDI editor during a second time period, comparing the first data to a second data defining the sound recording, and providing feedback data to the user, the feedback data comparing the first data to the second data. The first time period is separate from the second time period.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a flowchart illustration of an exemplary process, in accordance with at least some exemplary embodiments of the present disclosure;

FIG. 2 is a flowchart illustration of an exemplary process, in accordance with at least some exemplary embodiments of the present disclosure;

FIG. 3 is a schematic illustration of an exemplary computing device, in accordance with at least some exemplary embodiments of the present disclosure;

FIG. 4 is a schematic illustration of an exemplary network, in accordance with at least some exemplary embodiments of the present disclosure; and

FIG. 5 is a schematic illustration of an exemplary network, in accordance with at least some exemplary embodiments of the present disclosure.

### DETAILED DESCRIPTION AND INDUSTRIAL APPLICABILITY

The exemplary disclosed system and method may provide for audio information instruction. For example, the exemplary disclosed system and method may provide for instruction involving musical composition, speech-language pathology, foreign language instruction, voice instruction for performers such as stage performers, and/or any other suitable instruction involving audio information or data. For example, the exemplary disclosed system and method may be used with any desired type of audio information or data. It is also contemplated that the exemplary disclosed system and method may be utilized in applications such as instruction involving sound design and audio mixing, teaching sound design such as synthesis, and/or teaching ear training.

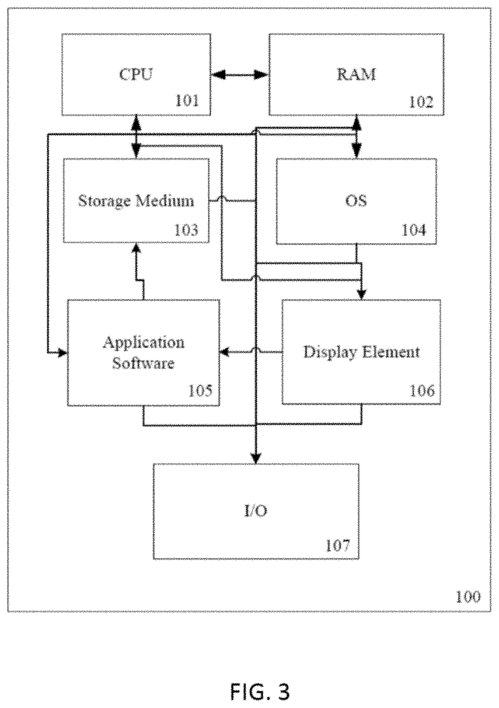

In at least some exemplary embodiments, the exemplary disclosed system and method may provide for teaching music composition within a Digital Audio Workstation (DAW) environment. For example, the exemplary disclosed system and method may provide for ear training (e.g., may provide a relatively heavy focus on ear training) for users. A user may utilize the DAW environment by using any suitable user interface or device such as, for example, a described below regarding FIGS. 3-5.

In at least some exemplary embodiments, the exemplary disclosed system and method may provide a lesson that includes an interactive challenge. The interactive challenge may include any suitable musical instrument digital interface (MIDI) device, system, and/or technique. The interactive challenge may involve a MIDI Editor or MIDI Grid (e.g., a Piano Roll). For example, the exemplary system and method may include a DAW including any suitable editing component such as a MIDI Editor or MIDI Grid (e.g., a Piano Roll). For example, a user may utilize a MIDI Editor or MIDI grid in a DAW environment by using any suitable user interface or device such as, for example, a described below regarding FIGS. 3-5. The MIDI Editor or MIDI Grid (e.g., a Piano Roll) may allow users (e.g., composers) to add and/or edit notes within a grid structure or other suitable structure, which may be played back by the exemplary disclosed system (e.g., a computing device as described for example herein). For example as described herein, the exemplary disclosed system may present users with audio information (e.g., a song such as a “hidden” song) that the users may hear but may not see (e.g., may not see a series of notes such as musical notes of a song that may be displayed on a MIDI Grid). The exemplary disclosed system and method may then provide the user with one or more opportunities to recreate this audio information (e.g., hidden song) using any suitable editing device or component such as a MIDI Editor or MIDI Grid (e.g., a Piano Roll).

The exemplary disclosed system and method may include an audio instruction module, a processor, and a user interface that may each include similar components as described below regarding FIGS. 3-5. The audio instruction module may comprise computer-executable code stored in non-volatile memory.

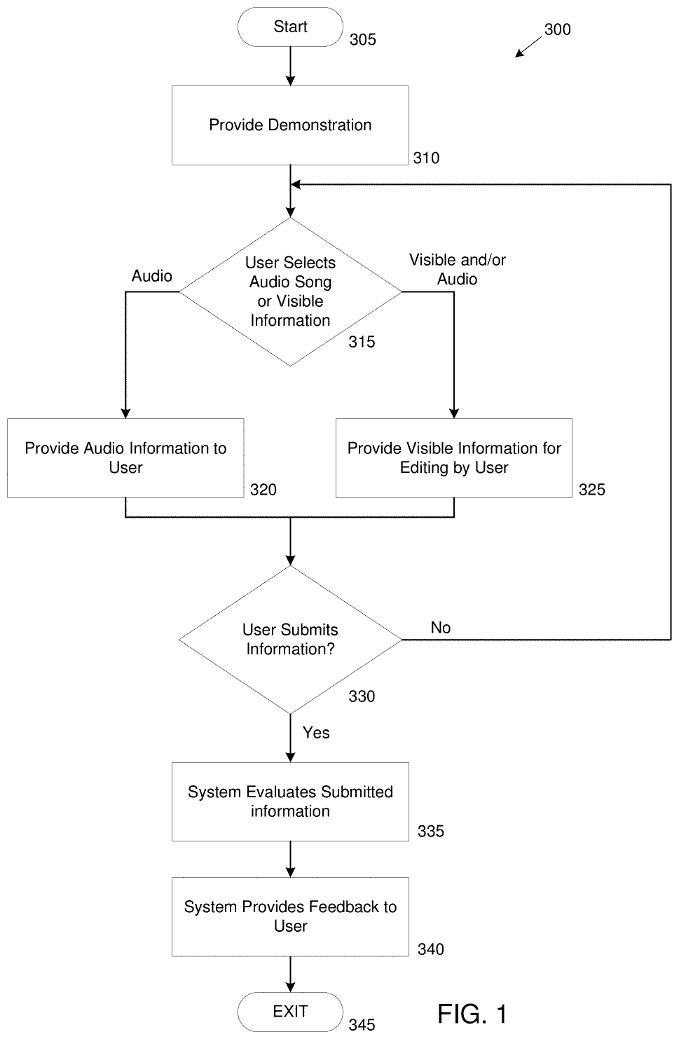

FIG. 1 illustrates an exemplary process of at least some exemplary embodiments of the present disclosure. The exemplary disclosed system and method may allow for users to change or switch between a first mode in which audio information is provided to a user and a second mode in which a visual display of that audio information is provided to the user. Although the second “visible” mode may include audio information, it may not provide a display of the first “hidden” mode's audio information. For example, each mode may have its own audio information. The user may utilize the visual display of data to modify the data using the exemplary disclosed system. In at least some exemplary embodiments, the user may add (e.g., not just modify) data, as the display may be empty when the challenge starts. The exemplary disclosed system and method may compare predetermined or actual audio information data to data modified by the user and provide feedback to the user.

As illustrated in FIG. 1, an exemplary process 300 may start at step 305. At step 310, the exemplary disclosed system may provide an instruction module or instruction information such as a video demonstration, text description, or audio module to a user. The instruction information may provide instruction on a given topic such as, for example, a music composition topic, a foreign language instruction topic, a speech-language instruction topic, a singing or voice-acting or control topic, or any other suitable topic.

After providing the instruction information to a user, the exemplary disclosed system may initiate an exercise (e.g., a challenge or other suitable interactive exercise). For example, the exemplary exercise may be a music composition exercise, a speech-language pathology exercise, a foreign language exercise, a voice instruction exercise for performers such as stage performers, and/or any other suitable exercise. In at least some exemplary embodiments, the exercise may allow the user one or more opportunities to recreate audio information or data such as a “hidden” song using instruction information that was provided at step 310.

At step 315, the exemplary disclosed system may prompt the user to select between a plurality of modes of operation of the exemplary disclosed system. For example, the user may select a first mode in which the exemplary disclosed system may provide audio information (e.g., play a song such as a hidden song) and a second mode in which the exemplary disclosed system may provide visual information or data (e.g., or tactile or other non-audio data) that may be edited by the user (e.g., using a computing device as described below regarding FIG. 3) to create a visible song. The information may be any suitable audio data or information as described for example herein. For example, the audio information of the first mode may be a song (e.g., “hidden song). In at least some exemplary embodiments, the exemplary disclosed system may provide a single type of data that may be audio data (e.g., only audio date) in the first mode. For example, the exemplary disclosed system may provide the user with a single type of audio information (e.g., a song). In the second mode, the exemplary disclosed system may provide a single type of data that may be a visual representation of the data (e.g., may be only a visual representation and may or may not include audio information). The second mode may also include audio data that the user may or may not be allowed to hear. A user may create a visible song in the second mode that may be identical to the hidden song of the first mode or may be any desired song (e.g., based on the lesson of instruction at step 310). In at least some exemplary embodiments, the visual data may be information provided using a visual display such as an editing component described for example herein. For example, the visual data may be provided by a MIDI Editor or MIDI Grid (e.g., a Piano Roll). For example, the visual data may be music composition data that may be edited by a user to reflect or match audio data that the user listens to during the first mode. For example, a user may edit data to add new data and/or modify existing data. The exemplary disclosed system may also automatically select a mode of operation for the user. For example, the exemplary exercise may begin with the exemplary disclosed system and method automatically operating in the first mode to provide audio information (e.g., to play a song or provide any other desired audio information).

In at least some exemplary embodiments, the exemplary disclosed system may operate in a first mode at step 320 (e.g., in which audio information is provided to the user as described for example above). For example, the exemplary disclosed system may play a song (e.g., or provide a foreign language recording or any other suitable information as described for example herein). At step 320, a single type of information may be provided to the user (e.g., audio information), and no additional information (e.g., no visual information) may be provided to the user.

In at least some exemplary embodiments, the exemplary disclosed system may operate in a second mode at step 325 (e.g., in which visual information or other non-audio information is provided to the user as described for example above). For example, the exemplary disclosed system may use an exemplary user interface as described for example herein (e.g., a computing device, a smartphone, a tablet, or any other suitable device) to provide visual information such as an editing device or component to the user. For example at step 325, the exemplary disclosed system may display or provide an editing component such as a MIDI Editor or MIDI Grid (e.g., a Piano Roll). At step 325, a single type of information may be provided to the user (e.g., visual or non-audio information or data such as an editing component as described for example herein), and no additional information (e.g., no audio information) may be provided to the user. At step 325, audio information may be provided along with and represented by the exemplary visual information (though, for example, the user may or may not be allowed to hear this audio information). In at least some exemplary embodiments, the visual or non-audio information may be indications of musical notes.

After selecting the first mode at step 320 or the second mode at step 325 (e.g., either by selection by the user or automatic selection by the exemplary disclosed system), the user or the exemplary disclosed system may return to step 315 (e.g., at step 330, the user or system may select to no submit information for evaluation and to return to step 315). The user or system may thereby iteratively repeat any sequence of modes of operation of the exemplary disclosed system. For example, the user or system may move back and forth between steps 320 and 325 as desired.

In at least some exemplary embodiments, a user may listen to audio information such as a song at step 320 during a first mode of operation (e.g., in which the exemplary disclosed system provides audio information as the single type of data and does not provide non-audio data). The user may then return to step 315 and select the second mode of operation of step 325. The user may then edit the visual information that may indicate or represent the exemplary audio information (e.g., the audio information as described for example above) that the user had just listened to at step 320 or may be any other desired information. For example, the user may create a visible song in the second mode that may be identical to the hidden song of the first mode or may be any desired song (e.g., based on the lesson of instruction at step 310). For example the user may use an editing component such as a MIDI Editor or MIDI Grid (e.g., a Piano Roll) to modify music composition data to match the song that the user has listened to at step 320. The user may iteratively proceed through steps 315, 320, 325, and 330 to move back and forth between the modes of operation. The user may repeat the same mode of operation and/or operate in any desired order of modes of operation. For example, the user may listen to a song at step 320, make one or more (e.g., a few) changes at step 325, return to listening to the song at step 320, return to the editing of visual information at step 325, and continue to iteratively work in any desired order. The exemplary disclosed system and method may thereby help the user to improve his or her musical composition abilities via ear training. The user may similarly improve any other abilities related to audio information such as, for example, foreign language ability, speech-language ability, voice control ability, and/or any other desired abilities related to audio information.

As a user moves back and forth between the exemplary modes described above, the user may make the visual data and its corresponding audio data provided at step 325 become increasingly close to the audio information provided at step 320. For example by moving back and forth between the exemplary modes described above (e.g., steps 320 and 325), the user may edit the visual or non-audio data at step 325 until it is substantially exactly the same (e.g., identical) to the actual audio information (e.g., song) of step 320. For example, the visual data edited at step 325 may be modified by the user until it is a musical or audio representation of the song played at step 320.

At step 330, a user may decide to submit the edited visual or non-audio data and its corresponding audio data that was edited at step 325 to the exemplary disclosed system for evaluation. For example, the user may submit the data edited at step 325 to the exemplary disclosed system for evaluation when the user feels that the edited data is identical to the song (e.g., or other audio information) played at step 320. The exemplary disclosed system may move to step 335 to evaluate the data submitted by the user for evaluation. The exemplary disclosed system may compare the submitted edited data of step 325 with predetermined or actual data representing the audio information of step 320. For example, the exemplary disclosed system may record or indicate each portion of edited data of step 325 that correctly represents the audio information (e.g., song) of step 320 and each portion that incorrectly reflects the audio information. The exemplary disclosed system may determine a value or score for the data of step 325 that was submitted by the user based on how closely that data matches the predetermined or actual data representing the audio information of step 320. For example, as the edited submitted data of step 325 more closely matches the predetermined or actual information of step 320, the exemplary disclosed system may provide a relatively higher score. For example, if the user submits edited data of step 325 that is identical to the predetermined or actual data of the audio information (e.g., song) of step 320, the exemplary disclosed system may assign a perfect score (e.g., 100% or other desired indication of a value or score).

At step 340, the exemplary disclosed system may provide output regarding the evaluation and/or analysis of step 335 to the user. For example, the exemplary disclosed system may provide output via any exemplary user interface described herein (e.g., smartphone display, computing device, or any other suitable user interface). For example, the exemplary disclosed system may provide the output via the same display or user interface through which the user edited the visual information or data at step 325. The exemplary disclosed system may use any suitable or desired graphical method, visual method, audio method, or other method for providing output to the user. For example, the exemplary disclosed system may indicate correct and/or incorrect edited data directly on the display or other user interface used by the user at step 325. For example, correct edited data may be shown in green, and incorrect edited data may be shown in red (e.g., along with a numerical score such as a percentage, a letter grade, and/or any other suitable rating system). The user may thereby receive precise feedback regarding the portions that the user edited correctly and the portions that the user edited incorrectly. Data that is missing (e.g., missing notes) may appear as empty white squares or any other desired indication.

Exemplary process 300 may end at step 345. A user may repeat process 300 as desired (e.g., may repeat steps 315 through 340) to complete the same or new exercises. For example, users may return to step 315 to repeat the exercise using a new song. Also for example, users may not repeat step 310 to encounter a new demonstration (e.g., video) until beginning a new lesson of instruction. Any desired number of exercises of varying difficulty and/or length may be provided by the exemplary disclosed system. A plurality of scores or ratings provided at step 340 may be averaged or analyzed using any desired tools to provide additional feedback to the user. For example, a user may complete numerous exercises (e.g., numerous iterations of process 300) and may be provided with a total or final score (e.g., total average score and/or total weighted score weighted by any desired criteria).

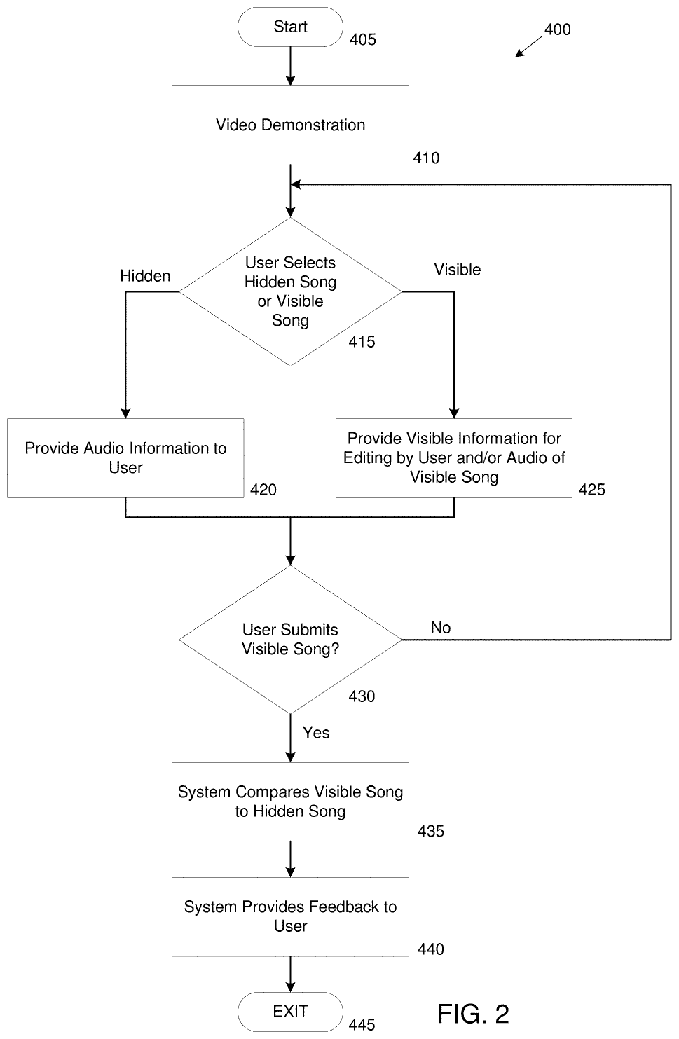

FIG. 2 illustrates another exemplary embodiment of the exemplary disclosed method. Process 400 illustrates a method for providing an instructional lesson such as a music lesson. Process 400 may allow for a user to utilize a MIDI Editor or a MIDI Grid in a DAW environment by using any suitable user interface or device (e.g., as described below regarding FIGS. 3-5) similar to for example as described above. Process 400 begins at step 405.

At step 410, a user may watch a video and/or audio demonstration of any desired musical composition topic (e.g., displayed by any suitable device such as for example as described below regarding FIGS. 3-5). After a user inputs data to the exemplary disclosed system via the exemplary disclosed device indicating that the video demonstration has been viewed or after a predetermined time period has elapsed, system 400 proceeds to step 415.

At step 415, the user may begin an interactive challenge that may reinforce and allow the user to demonstrate and be evaluated on the musical composition topic taught at step 410. For example, the user may begin the task of recreating a hidden song as described for example herein. At step 415, the user may select (e.g., by entering input data to an exemplary disclosed device such as described below regarding FIGS. 3-5) whether to listen to audio of a hidden song at step 420 or use the exemplary disclosed MIDI Editor or MIDI Grid in a DAW environment to edit and/or create a visual representation of the hidden song (e.g., and/or listen to this “visible” song) at step 425.

For example at step 420, the user may listen to a hidden song. For example, the exemplary disclosed user interface may audibly play a sound recording such as a song to the user. The user may not see any of the notes or other visual representation of the hidden song audibly played to the user at step 420.

For example at step 425, the user may utilize the exemplary disclosed MIDI Editor or MIDI Grid in the exemplary disclosed DAW environment by using one or more exemplary disclosed user interfaces or devices (e.g., as described below regarding FIGS. 3-5). The user may add and/or edit notes to the MIDI Editor or MIDI Grid (e.g., a Piano Roll) to create and/or edit a visible song corresponding to the hidden song played at step 420 (e.g., a visual representation of the hidden song). The user may create the visible song (e.g., create from scratch) or edit a nominal visible song that the exemplary disclosed system may initially provide to the user for editing (e.g., based on a skill level of the user and/or a difficulty level of the exemplary disclosed interactive challenge). The user may also listen to a sound recording (e.g., played by the exemplary disclosed user interface) based on (e.g., based on data of) the visible song that he or she has created and/or modified at step 425.

After the user performs actions as described above at step 420 or step 425, process 400 may proceed to step 430. At step 430, the user may enter input to the exemplary disclosed system to return to step 415 and repeat step 420 or 425 as described above. The user may iteratively repeat steps 415 through 430 as many times as desired or for a predetermined number or iterations or time limit controlled by the exemplary disclosed system. For example, the user may go back and forth between listening to the hidden song at step 420 and editing and/or listening to the visible song at step 425. The user may thereby improve his or her musical composition abilities via ear training. In at least some exemplary embodiments, step 420 may occur during a time period including a plurality of sub-time periods, which may occur separately from another time period including another plurality of sub-time periods during which step 425 may occur (e.g., each of the plurality of time periods may be interspersed with each other).

The user may continue to iteratively work through steps 415 through 430 until the user judges or believes that the hidden song played at step 420 matches (e.g., exactly matches) the visible song created and/or edited by the user at step 425. If the user judges or believes that the visible song matches the hidden song, the user may enter input to the exemplary disclosed system and process 400 may proceed to step 435. Process 400 may also automatically proceed to step 435 based on a predetermined period of time elapsing or a predetermined number of iterations of steps 420 and/or 425 having occurred (e.g., in the case of testing conditions).

At step 435, the exemplary disclosed system may compare data of the visible song entered by the user at step 425 to data of the hidden song played to the user at step 420. The exemplary system may determine a score that quantifies how closely the hidden song and the visible song match. Any suitable method or technique may be used to compare the data defining the hidden song and the visible song data provided by the user such as, for example, any suitable text summarization or data comparison method (e.g., determining whether each portion of the data is in the visible song data and not the hidden song data, is in the hidden song data and not the visible song data, is different, or is equal).

At step 440, visual feedback of the comparison may be provided to the user via the exemplary disclosed user interface or device. For example, visual feedback of the comparison may be displayed on the Piano Roll of the visible song to the user. The numerical score (e.g., or qualitative score) may increase as the hidden song and the visible song (e.g., data of the songs) more closely match each other. For example, any of the visible song's notes that match the hidden song's notes may be displayed in a first color (e.g., green) indicating correctness. Also for example, any of the visible song's notes that do not match the hidden song's notes may be displayed in a second color (e.g., red) indicating incorrectness. Further for example, any of the hidden song's notes that are missing from the visible song's notes may appear in a third color or indication (e.g., as empty white spaces).

Process 400 may end at step 445. A user may repeat process 400 for the same hidden song or move through any desired number of iterations of process 400 for multiple hidden songs demonstrating any desired musical composition topic. The exemplary disclosed system may provide individual scores for each iteration of process 400, average scores for related iterations of process 400 (e.g., a lesson average score for a plurality of hidden songs demonstrating the same topic or related topics), and/or an overall average score for substantially all iterations of process 400.

In at least some exemplary embodiments, the exemplary disclosed system may include an audio instruction module, comprising computer-executable code stored in non-volatile memory, a processor, and a user interface. The audio instruction module, the processor, and the user interface may be configured to provide a DAW environment for a user, provide a MIDI editor in the DAW environment to the user, audibly provide a sound recording to the user during a first time period, edit a first data using the MIDI editor during a second time period, compare the first data to a second data defining the sound recording, and provide a feedback data to the user, the feedback data comparing the first data to the second data. The first time period may be separate from the second time period. The audio instruction module, the processor, and the user interface may be further configured to audibly provide a second sound recording to the user during the second time period, the second sound recording being based on the first data. The feedback data may include a first data set of song notes that are displayed to the user via the user interface in a first color, the first data set of song notes being identically included in both the first and second data. The feedback data may include a second data set of song notes that are displayed to the user via the user interface in a second color, the second data set of song notes being different from each other in the first and second data. The feedback data may include a third data set of song notes that are displayed to the user via the user interface in a third color, the third data set of song notes being included in the second data and missing from the first data. The feedback data may include a numerical score based on the first data set, the second data set, and the third data set. The audio instruction module, the processor, and the user interface may be further configured to either audibly provide the sound recording to the user during the first time period or edit the first data using the MIDI editor during the second time period based on input data received from the user. The first time period may include a plurality of first time sub-periods and the second time period includes a plurality of second time sub-periods, each of the first time sub-periods and second time sub-periods occurring separately from each other. The user may iteratively provide the input data controlling the audio instruction module, the processor, and the user interface to either audibly provide the sound recording to the user during the first time period or edit the first data using the MIDI editor during the second time period. The audio instruction module, the processor, and the user interface may be further configured to display a video to the user at a time prior to the first time period and the second time period.

In at least some exemplary embodiments, the exemplary disclosed method may include providing a DAW environment for a user via a user interface, providing a MIDI editor in the DAW environment to the user, audibly providing a sound recording to the user during a first time period, editing a first data using the MIDI editor during a second time period, comparing the first data to a second data defining the sound recording, and providing feedback data to the user, the feedback data comparing the first data to the second data. The first time period may be separate from the second time period. The exemplary disclosed method may also include audibly providing a second sound recording to the user during the second time period, the second sound recording being based on the first data. The exemplary disclosed method may further include either audibly providing the sound recording to the user during the first time period or editing the first data using the MIDI editor during the second time period based on input data received from the user. The first time period may include a plurality of first time sub-periods and the second time period includes a plurality of second time sub-periods, each of the first time sub-periods and second time sub-periods occurring separately from each other. The user may iteratively provide the input data to either audibly provide the sound recording to the user during the first time period or edit the first data using the MIDI editor during the second time period, the plurality of first time sub-periods being interspersed with the plurality of second time sub-periods.

In at least some exemplary embodiments, the exemplary disclosed system may include a music instruction module, comprising computer-executable code stored in non-volatile memory, a processor, and a user interface. The music instruction module, the processor, and the user interface may be configured to provide a DAW environment for a user, provide a MIDI editor in the DAW environment to the user, audibly play a first song to the user during a first time period, edit a first data including song notes using the MIDI editor during a second time period, audibly play a second song to the user during the second time period, the second song being based on the first data, compare the first data to a second data defining the first song, and provide a feedback data to the user, the feedback data comparing the first data to the second data. The first time period may be separate from the second time period. The feedback data may include a first data set of song notes that are displayed to the user via the user interface in a first color, the first data set of song notes being identically included in both the first and second data. The feedback data may include a second data set of song notes that are displayed to the user via the user interface in a second color, the second data set of song notes being different from each other in the first and second data. The feedback data may include a third data set of song notes that are displayed to the user via the user interface in a third color, the third data set of song notes being included in the second data and missing from the first data. The feedback data may include a numerical score based on the first data set, the second data set, and the third data set.

The exemplary disclosed system and method may be used in any suitable application involving audio information such as musical composition, speech-language pathology, foreign language training, voice control or acting, and/or any other suitable application involving audio data or information. For example, the exemplary disclosed system and method may be used in any suitable application for teaching users to compose music. In at least some exemplary embodiments, the exemplary disclosed system and method may provide a computer-based training system having a curriculum that is provided to a user as described for example herein. For example, users may purchase or subscribe to access lessons (e.g., music composition lessons) provided by the exemplary disclosed system and method.

The exemplary disclosed system and method may provide effective teaching of music composition in a computer-based DAW environment (e.g., with minimal use of traditional notation and no music staff). The exemplary disclosed system and method may also help users to develop an ability to decipher pitches and rhythms by ear, as well as how to compose music directly within a DAW environment. The exemplary disclosed system and method may also efficiently eliminate the music staff and most traditional notation, and may instead teaching music composition directly within a DAW environment. For example, users may immediately apply what they have learned to any desired music-making environment (e.g., computer-based music-making environment). In at least some exemplary embodiments, by focusing (e.g., heavily focusing) on ear training, users may build an ability to create the music they hear, including for example music of their own artistic or mental creation or music from a recording.

An illustrative representation of a computing device appropriate for use with embodiments of the system of the present disclosure is shown in FIG. 3. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

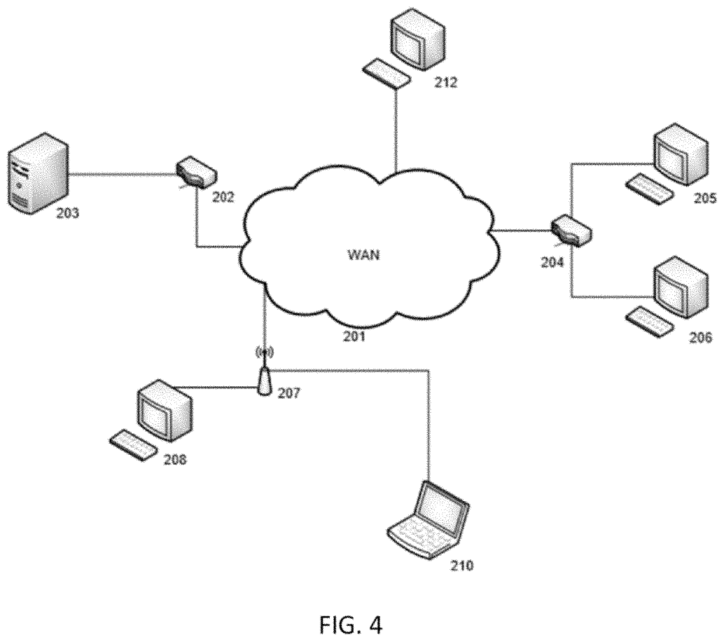

Various examples of such general-purpose multi-unit computer networks suitable for embodiments of the disclosure, their typical configuration and many standardized communication links are well known to one skilled in the art, as explained in more detail and illustrated by FIG. 4, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 4, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 4, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

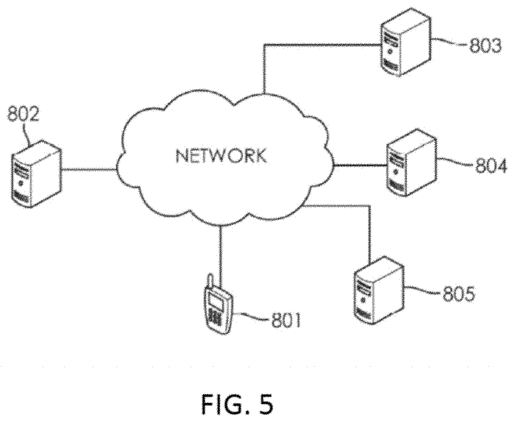

Turning now to FIG. 5, a continued schematic overview of a cloud-based system in accordance with an embodiment of the present invention is shown. In FIG. 5, the cloud-based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A system, comprising:
an audio instruction module, comprising computer-executable code stored in non-volatile memory;
a processor; and
a user interface;
wherein the audio instruction module, the processor, and the user interface are configured to:
provide a DAW environment for a user;
provide a MIDI editor in the DAW environment to the user;
audibly provide a sound recording to the user during a first time period;
edit a first data using the MIDI editor during a second time period;
compare the first data to a second data defining the sound recording; and
provide a feedback data to the user, the feedback data comparing the first data to the second data;
wherein the first time period is separate from the second time period.

2. The system of claim 1, wherein the audio instruction module, the processor, and the user interface are further configured to audibly provide a second sound recording to the user during the second time period, the second sound recording being based on the first data.

3. The system of claim 1, wherein the feedback data includes a first data set of song notes that are displayed to the user via the user interface in a first color, the first data set of song notes being identically included in both the first and second data.

4. The system of claim 3, wherein the feedback data includes a second data set of song notes that are displayed to the user via the user interface in a second color, the second data set of song notes being different from each other in the first and second data.

5. The system of claim 4, wherein the feedback data includes a third data set of song notes that are displayed to the user via the user interface in a third color, the third data set of song notes being included in the second data and missing from the first data.

6. The system of claim 5, wherein the feedback data includes a numerical score based on the first data set, the second data set, and the third data set.

7. The system of claim 1, wherein the audio instruction module, the processor, and the user interface are further configured to either audibly provide the sound recording to the user during the first time period or edit the first data using the MIDI editor during the second time period based on input data received from the user.

8. The system of claim 7, wherein the first time period includes a plurality of first time sub-periods and the second time period includes a plurality of second time sub-periods, each of the first time sub-periods and second time sub-periods occurring separately from each other.

9. The system of claim 8, wherein the user iteratively provides the input data controlling the audio instruction module, the processor, and the user interface to either audibly provide the sound recording to the user during the first time period or edit the first data using the MIDI editor during the second time period.

10. The system of claim 1, wherein the audio instruction module, the processor, and the user interface are further configured to display a video to the user at a time prior to the first time period and the second time period.

11. A method, comprising:
providing a DAW environment for a user via a user interface;
providing a MIDI editor in the DAW environment to the user;
audibly providing a sound recording to the user during a first time period;
editing a first data using the MIDI editor during a second time period;
comparing the first data to a second data defining the sound recording; and
providing feedback data to the user, the feedback data comparing the first data to the second data;
wherein the first time period is separate from the second time period.

12. The method of claim 11, further comprising audibly providing a second sound recording to the user during the second time period, the second sound recording being based on the first data.

13. The method of claim 11, further comprising either audibly providing the sound recording to the user during the first time period or editing the first data using the MIDI editor during the second time period based on input data received from the user.

14. The method of claim 13, wherein the first time period includes a plurality of first time sub-periods and the second time period includes a plurality of second time sub-periods, each of the first time sub-periods and second time sub-periods occurring separately from each other.

15. The method of claim 14, wherein the user iteratively provides the input data to either audibly provide the sound recording to the user during the first time period or edit the first data using the MIDI editor during the second time period, the plurality of first time sub-periods being interspersed with the plurality of second time sub-periods.

16. A system, comprising:
a music instruction module, comprising computer-executable code stored in non-volatile memory;
a processor; and
a user interface;
wherein the music instruction module, the processor, and the user interface are configured to:
provide a DAW environment for a user;
provide a MIDI editor in the DAW environment to the user;
audibly play a first song to the user during a first time period;
edit a first data including song notes using the MIDI editor during a second time period;
audibly play a second song to the user during the second time period, the second song being based on the first data;
compare the first data to a second data defining the first song; and
provide a feedback data to the user, the feedback data comparing the first data to the second data;
wherein the first time period is separate from the second time period.

17. The system of claim 16, wherein the feedback data includes a first data set of song notes that are displayed to the user via the user interface in a first color, the first data set of song notes being identically included in both the first and second data.

18. The system of claim 17, wherein the feedback data includes a second data set of song notes that are displayed to the user via the user interface in a second color, the second data set of song notes being different from each other in the first and second data.

19. The system of claim 18, wherein the feedback data includes a third data set of song notes that are displayed to the user via the user interface in a third color, the third data set of song notes being included in the second data and missing from the first data.

20. The system of claim 19, wherein the feedback data includes a numerical score based on the first data set, the second data set, and the third data set.
